(19) United States
(12) Patent Application Publication
(10) Pub. No.: US 2014/0129420 A1
(43) Pub. Date: May 8, 2014

(54) TELECOM SOCIAL NETWORK ANALYSIS DRIVEN FRAUD PREDICTION AND CREDIT SCORING

(71) Applicant: MASTERCARD INTERNATIONAL INCORPORATED, Purchase, NY (US)

(72) Inventor: Justin Xavier Howe, Larchmont, NY (US)

(73) Assignee: MASTERCARD INTERNATIONAL INCORPORATED, Purchase, NY (US)

(21) Appl. No.: 13/671,982

(22) Filed: Nov. 8, 2012

(51) Int. Cl. G06Q 40/02

(52) U.S. Cl. 705/38

(57) ABSTRACT

A method for scoring a user's propensity for credit fraud includes forming a social graph from Call Detail Records (“CDR”), the users being nodes and weighted edges connecting node pairs representing a relationship between those users. Initial scores are assigned to users. A first user/credit applicant final score is calculated as a sum of all weighted initial scores of users having a degree of separation of n with the first user, along a path of connecting edges on the social graph, each weighted initial score being a product of the weight of the edges connecting the corresponding node pair, the user initial score, and the inverse square of the degree of separation with the first user. The summation of the degree weighted initial scores of users with degree of separation of n or less is the first user's credit-fraud score.

### FIELD OF THE INVENTION

The present invention relates to a method and system for social network analysis of call histories, in particular, to a method for predicting behaviors affecting creditworthiness such as credit fraud, including bust out fraud, using social network analysis of call histories.

### BACKGROUND OF THE INVENTION

Methods are known for using on-line social networks, such as Linkedin, Facebook and MySpace, for analyzing social media driven behavior. The analysis of the behavior and relationships of users of these networks has already been applied in the financial industry. For example, addressing the problem of defining credit worthiness of small upstart businesses who have little or no past credit history, one company has recently initiated a credit scoring system based on one's trustworthiness and reputation as evidenced through these on-line social networks. This is a novel approach, but suffers from profound problems with data quality. For example, not all relationships are created equal. Acquaintances, co-workers and family members all look similar on social media and many connections (such as to parents or elderly family members) may never occur. The nature of such relationships may have a profound effect on the accuracy of predicting behavior based on communications within on-line social networks.

A different approach is also known that uses mobile phone data such as the number of text messages sent, the time of day and the location from which a user places telephone calls, and the duration of such calls to estimate creditworthiness. This approach may scale well to emerging markets where social media access is limited, but suffers from the problem of failing to fully leverage user data due to privacy restrictions and contractual restrictions imposed by telecommunication carriers. Because the details of call histories are not utilized for privacy reasons, this approach can not take advantage of the predictive power offered by this rich source of social network data. Furthermore, the approach does not address other problems of accurately relating mobile phone data with an associated user's creditworthiness posed by practices such as pooling (where several people share use of the same phone account, which may deceivingly appear in phone records as being associated with a single phone and user), or a single user's customary use of multiple phones for different purposes (as is common of iPhone users also carrying Blackberries, or users in countries without cross-carrier agreements).

As disclosed, for example, in U.S. Pat. No. 8,194,830 to Chakraborty, et al. (“Chakraborty”) which is incorporated herein by reference, telecom providers have also proposed to use data pertaining to interactions between their customers to identify those customers that are likely to churn (or change to a different provider). The predictions are based, for example, on the degree of connectivity and frequency of contact with others who also changed service recently. Chakraborty also discloses using the call history data to identify “influencers” or subscribers who frequently persuade their friends, family and colleagues to follow them when they switch to a rival operator. Once identified, such influencers can be targeted by a telecom provider with appropriate incentives to stay loyal to the current provider.

For reasons of privacy, legality, or the high sunk costs in their industry, telecom providers have not yet applied social network analysis of call histories to the field of credit prediction. However, there are a variety of anti-fraud, credit scoring, and financial compliance activities that could benefit from the use of this data. Furthermore, it is a promising avenue for supplementing thin-file credit reports via applicant opt-in, for situations where applicants would otherwise be turned away.

Bust out fraud is a type of fraud in which a cardholder tries to gain the largest credit line possible, and then spends his or her entire credit line with no intention of repayment. This behavior could be prompted, for example, by an anticipation of expatriation, or to convert merchandise to cash at a profit exceeding the collections amount. Unlike application fraud, it usually involves a long-term, deliberate, manipulation of financial institutions and practices to maximize the value of the fraud, by first posing as a good customer before maxing out one's credit and disappearing.

This type of fraud may or may not involve identity theft. However, it is known that many bust out artists do not work alone, but may be part of a team of people who are systematically attacking credit unions and banks once they have studied the financial institutions' programs. Moreover, small single operators may also influence others in their social circle to engage in bust out fraud schemes once they have succeeded in perpetuating the fraud.

There is currently no known method or system for analyzing call histories to define social networks and relationships for predicting behaviors affecting credit worthiness, such as bust out fraud.

### SUMMARY OF THE INVENTION

The present invention provides a method and system for analyzing call histories to define social networks and relationships for predicting behaviors affecting creditworthiness such as bust out fraud.

In one aspect of a method of the present invention, a computer-implemented method for calculating a score indicating a propensity of a person to engage in negative credit practices from telephone call records includes retrieving telephone call data comprising records of telephone calls between users and forming a social graph from the telephone call data, wherein the users are represented as nodes. An existence of a record of at least one telephone call between a pair of users is represented as an edge connecting the corresponding node pair on the social graph. A strength of a relationship of each of a plurality of second users having a degree of separation of one with a first user is determined using the social graph of records of telephone calls between users; and assigning a weight corresponding to the strength of the relationship to the edge connecting the corresponding node pair. An initial score is assigned to the first user and to each of the plurality of second users, which indicates a propensity for engaging in a negative credit practice. An initial score of zero indicates a lack of a record of engaging in the negative credit practice.

A score is then determined for the first user to engage in the negative credit practice by calculating a first degree cumulative score based on the initial scores assigned to the second users having a degree of separation of one and the weight of the edges connecting the corresponding node pairs.

In an additional aspect, the first degree cumulative score for the first user, resulting from the charted relationships with the second users having a degree of separation of one, is calculated by multiplying the initial score assigned to each of the second users by the corresponding weight of the edge connecting the corresponding node pair of second user/first user to form a weight score for each of the second users. The first degree cumulative score is then calculated by adding the plurality of weighted scores for the second users, i.e., users having a degree of separation of one with the first user.

In various additional aspects, the social graph formed from the call records can be utilized to determine the influence of additional users who have a higher degree of separation from the first user, who can be, in certain aspects, a credit applicant. In this aspect, the method includes identifying a degree of separation n with the first user for a user, where n is greater than 1, using the social graph of records of telephone calls between users, and a path connecting the user having the degree of separation of n with the first user. The path includes a set of edges connecting the corresponding node pairs formed between the user of degree of separation n and the first user on the social graph.

A weight is preferably assigned corresponding to a strength of a relationship between a pair of users represented by the corresponding node pair for each of the edges along the path using the records of telephone calls; and assigning an initial score to each user along the path from the user of degree of separation of n and the first user, the initial score indicating a propensity for engaging in a negative credit practice, a score of zero indicating a lack of a record of engaging in the negative credit practice. The score for the first user to engage in the negative credit practice is determined by calculating a degree-weighted score for each of the users along the path based on the initial score assigned to each user, the degree of separation of each user along the path and the first user, and the weight of the edges connecting the corresponding node pairs along the path.

The initial score assigned to each of the users along the path is preferably weighted by the corresponding weight of the edge connecting the corresponding node pair and by the inverse of the square of the degree of separation of the user along the path with the first user. Accordingly, a plurality of degree-weighted scores is calculated for the users along the path connecting the user with degree of separation n and the first user. The score for the first user is calculated by adding the plurality of degree-weighted scores to the first cumulative score and to the initial score for the first user to calculate the score for the first user. A higher credit score represents a higher propensity that the first user will engage in the negative credit practice.

In these and other various aspects, for each pair of users represented by the corresponding node pair on the social graph, the weight corresponding to the strength of the relationship between the pair of users can be determined based on at least one of a frequency of calls between the users, a total number of calls, an average call duration, a direction of calls, and an immediacy of a reciprocating call.

Each of the retrieved telephone call data records preferably includes at least a calling number, a receiving number, a time of call, a call duration, and a geolocation from which the telephone call originated, from which usage statistics can be generated for each calling number based on the details in the retrieved call data records.

The telephone call data is preferably filtered before forming the social graph, for example, by removing at least one of calls that are shorter than a predetermined duration, calls to or from business phone numbers, calls to or from customer service numbers, calls to a user's voicemail service, toll-free calls, calls to or from public phones.

In addition, in various additional aspects of the method of the present invention, the usage statistics can be applied to identify pooled numbers, which can then be removed from the records of the telephone call data before forming the social graph. Further, multiple calling numbers used by a single user can be identified.

The telephone call records of a single user associated with multiple calling numbers can then be assigned to an identification number associated with the single user, and a single node on the social graph used to correspond to the multiple calling numbers associated with the single user.

In various aspects of the present invention, the negative credit practice can be bust-out fraud or bankruptcy. In additional aspects, the score can be an indicator of non-compliant merchant behavior.

In additional various aspects, the edge connecting node pairs can be directed edges, preferably directed toward the first user on the social graph, where the weight of the directed edge is calculated to reflect a degree of influence of one user over an other user in the corresponding node pair, the one user having a higher degree of separation from the first user than the other user in the node pair.

In still other aspects, the initial scores indicating a propensity for engaging in the negative credit practice are derived from a credit bureau or credit reporting agency.

In addition to the above aspects of the present invention, additional aspects, objects, features and advantages will be apparent from the embodiments presented in the following description and in connection with the accompanying drawings.

### BRIEF DESCRIPTION OF THE FIGURES

FIG. 1 is a schematic representation of an embodiment of a method in accordance with the present disclosure for preparing call data for social network analysis.

FIG. 2 is a schematic representation of an embodiment of a method in accordance with the present disclosure for applying social network analysis to call data for predicting potential sources of bust-out fraud.

FIG. 3 is a schematic representation of an embodiment of a system for implementing various embodiments of the methods of the present disclosure.

### DETAILED DESCRIPTION OF THE EMBODIMENTS

The following sections describe exemplary embodiments of the present invention. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto.

The present invention provides a method and system for analyzing call histories to define social networks and relationships for predicting behaviors affecting creditworthiness. In particular embodiments described herein, the method and system for analyzing social networks and relationships are applied to calculating a bust out score for predicting bust out fraud. However, one skilled in the art will recognize that the method can also be applied to calculating a credit score, including thin file credit scoring for developed markets, a bankruptcy score for predicting bankruptcy, a score indicator of non-compliant merchant behavior, without departing from the spirit and scope of the invention.

The term “geolocation” as used herein refers to a user's “exact” location and can include a street address, GPS positioning data, triangulated positioning data, or other location data of a user. “Regions,” or “georegions,” can be defined from groupings of geolocation data and can refer to cell phone tower broadcast areas, metropolitan areas, counties, states, or other groupings.

As a preliminary matter, it is assumed that credit recipients have granted access to their phone records to a credit reporting agency, financial institution, or other party for the sole purpose of predicting their credit worthiness. It is also assumed that these permissions would be used to retroactively examine the credit applicant's phone history, as well as to use the credit applicant's information to predict the credit worthiness of future applicants, and that these permissions are granted for all phone numbers owned (present/past/future) by the credit applicant as a condition of the credit inquiry. Alternatively, it is assumed that the necessary access has been legally obtained without explicit permission of the credit applicant, for instance, due to a legally authorized criminal investigation.

It is also understood that, depending on applicable law, cardholders and telephone users may need to be notified of the processes by which various information is obtained, as described herein, by their issuer and/or mobile network operator. In certain cases, under applicable laws, even if one's privacy and security is protected, specific consent may be needed to collect and include users' information in the relevant tables described herein.

The generation of geotemporal fingerprints of a user's activity is useful for many applications, including for identification of payment card fraud without the need for an enrollment or registration process. Although, appropriate specific consent may be warranted.

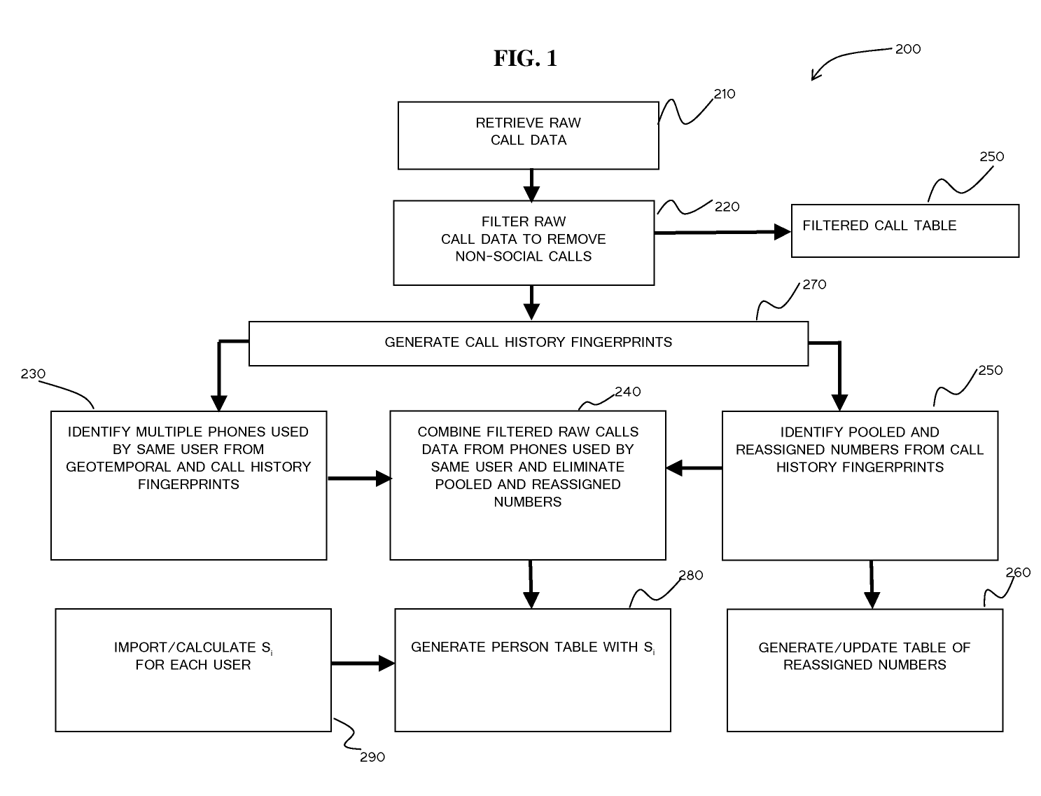

Referring to FIG. 1, in one embodiment of a method in accordance with the present invention for preparing call data for social network analysis 200, a listing of Call Detail Records (CDR) is retrieved 210 for a plurality of telephone users or subscribers to one or more telecommunications provider, and an initial call history table, with records of both calls placed and calls received, is generated. Each record in the call history table preferably includes an account number or other identifying number associated with the owner of the phone from which the call was dialed or on which the call was received, at least a phone number from which the call is dialed, a cell tower through which a call is routed, cell tower geolocation, or phone geolocation from which the call is placed, a time and date of the call, and a duration of the call.

Additional details can be pulled into the call history table from the CDR, which are useful in determining the weighted relationships between callers in accordance with various embodiments of the present invention. The types of details which can be pulled in from the CDR to generate a call history table include, but are not limited to:
a. Dialing Phone Number
b. Receiving Phone Number
c. Holiday Flag
d. Day of the Week
e. Time Stamp
f. Date Stamp
g. Duration of Call
h. Flag for during workday
i. SMS_history data—with same information as listed in a through 1 above
j. Number of rings before pick up
k. Response Flag: Generate a call-level flag to indicate if a call was reciprocated with a response.
l. Response Time: If the call-level response flag is populated, populate a field with the length of time until a response is received.
   i. As an indicator of influence: employees, for example, respond to calls from their bosses faster than bosses respond to calls from subordinates.

To prepare the CDR for analysis, a filtered call history table 150 is preferably generated 220 from the initial call history table. For example, all records of calls that are shorter than a predetermined duration, such as 20 seconds, are removed. In addition, all records of calls that originated or terminated at business phone numbers, customer service calls, calls to one's voice mail service, 1-800 calls, and other similar business and service-related calls, are preferably identified and removed.

For this purpose, a database or table of business listings may be provided, which includes numbers for all commercial or public enterprises, at least within a particular area code or region.

Similarly, a database or table of public phones may be provided which lists the numbers of all public phones, or communal phones, for removal of those call records from the CDR to generate the filtered table 150. These phones should also be identifiable from an analysis of the CDR, because they will have hundreds of outbound calls and few inbound calls. A table of Unusable Numbers is also accessed to remove numbers whose use is forbidden by law, such as doctor's offices, embassies, political organizations, or religious organizations in the United States. The filtered data records are exported to generate the filtered call history table 150.

As described in more detail below, once the data is filtered to remove the unwanted records, a process is preferably implemented to identify all phones numbers associated with a single person 230 in order to compile a complete record of that person's calling and/or texting patterns before applying social network analysis. Once identified, the filtered call history data recorded in table 150 for all phone numbers associated with a single person are combined to form a record of that person's complete call history 240. These call histories are stored for each person, for example, and preferably associated with an identifying number (e.g., SSN), in a table referred to herein as a “Person Table.” To further increase the reliability of the social network analysis, call records from phones which are pooled under a common phone number, for example, or which have been reassigned, are eliminated from the Person Table 250.

The Person Table also preferably includes an indicator or score, “sᵢ,” which is regularly updated, as an indication of a particular credit-related behavior. In the embodiments described in reference to FIGS. 1-3, sᵢ is an indicator of each person's propensity to commit bust out fraud. Records of bad credit data, including indications of engaging in bust-out fraud, for generating a score sᵢ associated with each person or user are generally maintained by and available for linking with the identifying number from various credit bureau reporting agencies.

### Generation of a Person Table

The practice of maintaining multiple phone numbers is not uncommon. For example, particularly in developed countries, employees may carry personal iPhones and Blackberries for business. In certain emerging economies, people also may carry more than one phone, for different networks, because of exorbitant cross-network charges.

To improve the accuracy of the social network analysis, therefore, it is desirable to associate all phone numbers that a single user uses with that person, and to maintain updated accurate information of such data, for example, by identifying phones that are reassigned and identifying pooled phones. Such information is not generally explicitly available from raw call history records.

Accordingly, to develop a more accurate record of call data associated with a single person, in one embodiment, a “Telephone Use” listing or table of telephone numbers is first generated from the filtered call history data 150, with one record for each phone number. The Telephone Use table contains certain information from the CDR 150, which is also used to generate certain usage statistics and information related to each number to help identify the user of the telephone number. Preferably, the Telephone Use table contains information for each number, such as:
a. the time period where usage statistics have been consistent;
b. the Account Number;
c. popularity statistics such as
   i. Number of inbound calls or text messages
   ii. Number of unique inbound calls
   iii. Number of calls at peak recreational times such as Friday night;
d. total Relationship Strength: Sum of total minutes communicated with non-‘Business_Listing’ phone numbers; and
e. a probability that the phone number is pooled.

It should be clear to one of skill in the art, that the probability that a phone number is pooled can be readily calculated from phone records associated with that number. Accordingly, a probability that the phone number is pooled can also be generated and stored in the Telephone Use table.

Similarly, a determination of different phone numbers that are used by the same person can be made 230 using data from the “Telephone Use” table, for example, by:
a. identifying phones that are in immediate proximity for large periods of time.
b. generating a geotemporal fingerprint (a series of geolocations/georegions and timestamps that describes someone's travels over a period of time) associated with each phone number and correlating geotemporal fingerprints associated with different phone numbers; and
c. generating a call history fingerprint for each phone number 270 (a series of relationships that are maintained over a period of time, used to uniquely identify users).

The generation of geotemporal fingerprints is described, for example, in co-pending patent application Ser. No. 13/671,791, filed on the same day herewith, under Docket No. 1788-94, entitled “Methods For Geotemporal Fingerprinting,” the disclosure of which is incorporated herein in its entirety.

In one embodiment, the call history fingerprints are generated from the filtered CDR and can be stored 270 in a “Call History Fingerprint” table, which includes a listing of each telephone number and, preferably, the associated user identifying number, with a compressed form of numbers called, the duration, frequency and time over a certain period of time. This fingerprint can be used to detect when phone ownership has changed (phone has been reassigned) 250 by comparing changes in fingerprints examined at different snapshots in time. Once a change of ownership of a phone is identified, the call data from that phone is no longer included in the call history data associated with that user. A record of phone numbers that have been reassigned (changed ownership) or turned off may be maintained in a separate table 260 for future reference.

Once the phone numbers associated with a single user have been identified 230, and pooled and reassigned phones have been removed as necessary 250, the filtered call history data recorded in table 150 for all phone numbers associated with a single person are combined 240 to form a record of each person's complete call history. These call histories are stored for each person, for example, preferably with the person's identifying number (e.g., SSN), in the “Person Table” 280 for analysis of relationships in the determination of negative credit behavior such as bust-out fraud.

The Person Table is generated with one record per person or user, preferably associated with an identification number such as a SSN, combining multiple phone use by the same person, when applicable, as determined from the Telephone Use table and analysis described above. The Person Table combines the call histories 150 and relevant data from all phone numbers under a single person or user, after filtering as described above with removal of misleading information from pooled phones and so on. In addition, in one particular embodiment, the Person Table lists a Bust-Out Fraud Score for each person, which can be imported or calculated 290 from credit bureau data or other sources. Additional information that can be listed in the Person Table includes the geotemporal and call history fingerprints associated with the person, along with other summary information, such as one or more of:
a. total number of calls made by the person;
b. minutes used;
c. demography inferred from estimated home geolocation;
d. whether the user has a mobile or stationary job;
e. determination of home geolocation;
f. number of flashed calls;
g. number of wrong numbers; and
h. count of phones only called once.

The filtered and compiled call history records associated with each person provide reliable data for forming a social graph and then performing social network analysis based on historical call data.

Social Network Analysis of Call Data Histories for Predicting Negative Credit Behavior, such as Bust-Out Fraud

Preferably, the analysis is formed on call history data, which has been filtered as described above, and processed, for example, so that each node represents a single user (and thus possibly multiple phone listings for users having more than one phone).

In one embodiment of a method for social network analysis of call history data, evidence of direct contact (indicated herein as a degree of separation of one (1)) of a credit applicant with a user or users who engage in bust out fraud, for example, is used to predict the probability that the credit applicant will also engage in bust-out fraud. In one example, a phone number is identified as being associated with a user who is known to have committed bust-out fraud. A ratio or number of phone calls (number of unique phone numbers or other metric) between one or more phones associated with the credit applicant and the fraud-associated phone number (and other phone numbers associated with its owner) is monitored. If the number exceeds a predetermined threshold for a particular credit applicant's call history, an alert is issued to warn of a potential credit risk associated with the credit applicant.

In an alternative embodiment, a number of phone calls to and from proximate bust out callers, or callers exhibiting bust out behavior who have no direct contact to the applicant, but who have contacts in common with the applicant (i.e., with a degree of separation greater than 1) are also accounted for. The degree of influence of these proximate callers on the credit applicant can be taken into account by ascribing a lower weighting factor to activity exhibited by callers with a higher degree of separation with the credit applicant. Communications can be flagged which correspond to a predetermined degree of separation and degrees below that predetermined number for triggering an alert to issue a warning of potential credit risk, and/or to perform additional analysis. In this fashion, credit applicants with no immediate contacts to bust-out fraud perpetrators, but having contacts in common with known perpetrators, can be identified.

In another preferred embodiment of a method for social network analysis of call history data, a relationship weighting is assigned between two callers by analyzing the call history data. The relationship weighting indicates a degree of significance to the nature of relationships between callers or users.

For example, a frequency of calls between two users implies a deeper relationship. Calls made during the work day indicate a different type of relationship than those made on weekends or at night. Accordingly, in one embodiment, after call histories for phone numbers associated with the same user are collected and combined, as described in regard to forming the Person Table, for example, the call history data associated with each user is examined to calculate call frequency, call direction, and immediacy of response. This data is then used to determine connections between various callers and the strength of their respective relationships.

One of skill in the art will appreciate that such data can readily be plotted or visualized on a social graph, in which each caller is represented as a node, and relationships between any two callers are represented as edges. In certain preferred embodiments, the node is not associated with a single phone number, but with the user or person and associated identifying number, such that a single node may represent more than one phone used by the caller. The strength of the relationship between two nodes is indicated by a weight of the edge, where call data such as call frequency, call direction, and immediacy of response as well as other factors can be used to ascribe a numeric weight to the edges, indicating the strength of relationship between any two callers via any method known in the art, such as, predictive modeling, logistic regression, neural networks, or other machine learning techniques as described, for example, in U.S. Pat. No. 8,194,830 to Chakraborty, which is incorporated herein by reference. In one embodiment, a weighted edge can be one that represents an overall strength of the relationship as indicated by a total number of calls between users i and j. In various preferred embodiments, the weights ascribed herein are those of directed edges. A directed edge from a first caller (node) to a second caller (node) is ascribed a weight of the relationship of the first to the second caller, i.e., indicating a weighted influence of the first caller over the second. Likewise, a second directed edge from the second to the first caller between the nodes is ascribed a weight of the relationship of the second to the first caller. The second directed edge may or may not have the same weight as the first, depending on the relationship between the callers. For example, the weight Wᵢⱼ of a directed edge <i, j> can represent the aggregate of all calls made by i to j, whereas the weight of a directed edge <j, i> would represent the aggregate of all calls made by j to i.

As referred to herein, the connectivity of nodes relative to a so-called central node, the central node representing the credit applicant under scrutiny in the example provided, can be characterized in terms of “degrees of separation.” For any node that has a direct telephone exchange with the central node, represented by an edge directly connecting the node to the central node, the degree of separation is “1.” For each node not directly connected via an edge to the central node, but that has a telephone exchange with a node that, in turn, has a direct telephone exchange with the central node, the degree of separation is “2,” and so on.

Additional factors that can be used to calculate a weight of a relationship from the call history data as described herein include the geolocations of each caller at the time of the call, and the time of day and day of the week of the calls. Such factors can indicate a family or working relationship, both of which may be inferred from a multiplicity of shared contacts. Calls placed during working hours can also indicate business contacts or coworkers, depending on the relative geolocations of the two callers. The nature and strength of a relationship between callers can also be inferred by data points such as call duration, the number of calls within a particular time, the time of call, expense of the call and sensitivity to peak usage and so on. In addition, the influence of one caller over another may be demonstrated by how promptly a call is answered or reciprocated.

Relationship data can also be incorporated into “relationship tables” listing statistics calculated from the filtered call history data for each pairing of nodes or phone numbers for use in assigning weights between nodes. As described, for example, in generating the Person Table, in certain preferred embodiments, the nodes may represent persons or identifying numbers associated with more than one phone. In additional embodiments, one record for each direction (directed edge) of communication is generated. Examples of data and statistics that can be included in the Relationship Table for each node are:
a. Direction of Communication (one entry for each direction);
b. Response Ratio: the percentage of time that a call is responded to;
c. Average Response Time: the average response time for a call;
d. Outbound_Frequency: the number of calls from phone A to phone B;
e. InBound_Frequency: the number of calls from phone B to phone A;
f. Ratio of Text Messages to Phone Calls;
g. Percentage of Calls During the Workweek (to distinguish professional relationships); and
h. Percentage of Calls on Weekends (to distinguish professional relationships).

These, and other factors described herein, are applied in various embodiments to generate a weighting factor for each directional edge.

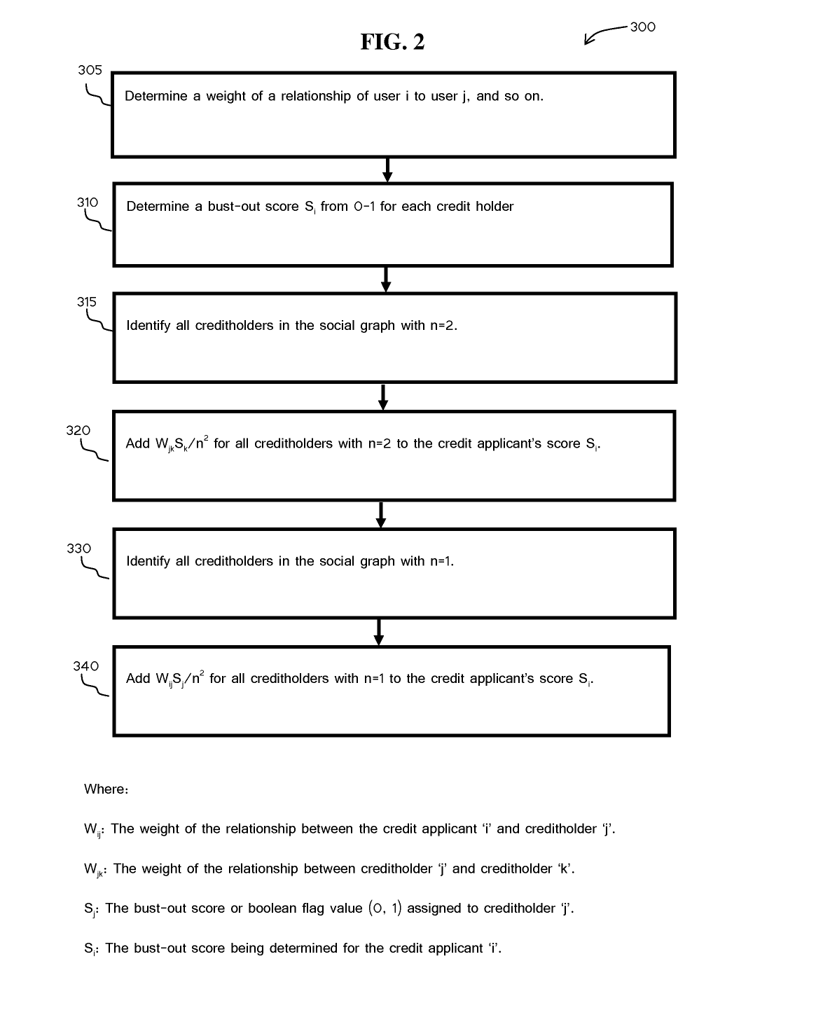

Referring to FIG. 2, in an embodiment of a method for applying social network analysis to call data to predict bust-out fraud 300, for example, once the relationships between users have been ascribed a weight w 305, a bust-out fraud score can be calculated for a particular user as follows. For a user i, who may be a credit applicant, for example, a weight wᵢⱼ of a relationship of user i to a known creditholder, user j, is assigned from the relationship data plotted in the social graph or from the relationship table. In addition, a weight Wⱼₖ of a relationship of a creditholder j to another known creditholder, user k, is also assigned. In the case where no relationship exists between credit applicant and creditholder, wᵢⱼ is zero. Similarly, if no relationship exists between creditholder j and creditholder k, Wⱼₖ is zero.

A bust-out score sⱼ of (0,1) is assigned to creditholder j based on whether the creditholder j is known to have engaged in bust out fraud (1) or not (0) 310. Alternatively, in step 310, a weighted bust-out score between 0 and 1 can be assigned to indicate the likelihood that creditholder j will engage in bust-out fraud, based on the creditholder's history. Indications of activity statistically linked to bust-out fraud may be obtained from credit bureau reports, as described, for example, in U.S. Pat. No. 8,001,042 to Brunzell, et al., which is incorporated herein by reference, and include: an account balance approaching or exceeding the credit limit, bouncing checks, requesting credit limit increases and/or the addition of authorized users, frequent balance inquiries, and overuse of balance transfers and convenience checks.

A minimum degree of separation n between the credit applicant i and creditholder j is also determined from the call history data. Referring to FIG. 2, one embodiment of a method of the present invention 300 includes identifying all creditholders in the social graph with a minimum degree of separation n of 2 from a credit applicant i 315. Next, a weighted bust-out score is calculated as a summation Σₖ (wⱼₖsₖ)/n² for n=2 over all creditholders k with a degree of separation of 2 from a credit applicant/caller i 320. The use of directed graphs more accurately represents the asymmetric nature of influence, in that a user j may have substantial influence over user k but the converse may not be true. Accordingly, different weights can be assigned to each direction of the relationship, with the expectation of improved predictive performance of user behavior.

Referring still to FIG. 2, in step 330, all creditholders are also identified which have a minimum degree of separation of 1 with credit applicant i. In step 340, a weighted bust-out score is calculated as a summation Σⱼ (wᵢⱼsⱼ)/n² for n=1 over all creditholders j with a degree of separation of 1 from a credit applicant/user i. The results of step 320 and step 340 are added to credit applicant's starting bust-out score sᵢ, which, in one embodiment, is zero if no previous bust out analysis has yet been performed.

In various other embodiments, additional weighted bust-out scores can be similarly calculated for higher degrees of separation and added to the cumulative sum of the bust-out score for credit applicant i. In yet another embodiment, the cumulative sum for all callers with some degree of connectivity is calculated. Accordingly, sᵢ provides a bust-out fraud prediction score for user/credit applicant i that accounts for the strength of relationships and degrees of separation with those users who engage in, or have a non-zero probability of, engaging in bust-out fraud.

In additional embodiments, once sᵢ is calculated, the social graph can be traversed and the score for other users connected to user i can be adjusted according to the method 300 for calculating a bust-out score in an iterative approach until convergence is reached for a plurality of connected users.

### System for Implementing the Methods of the Present Disclosure

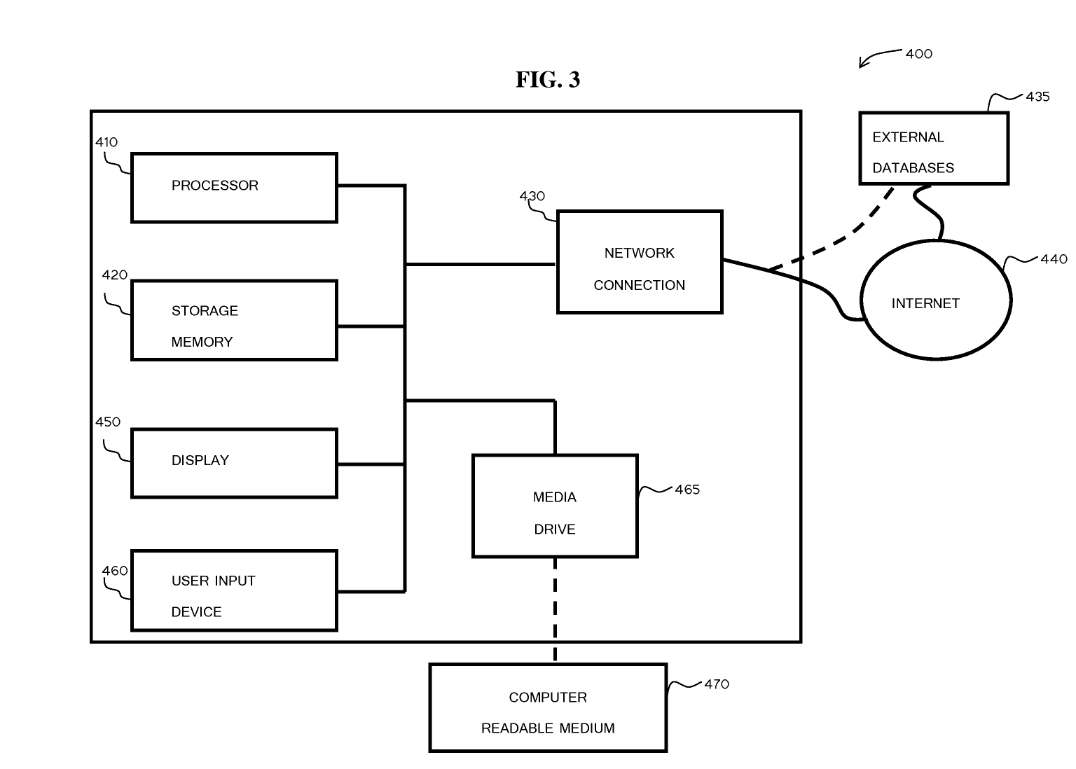

Referring to FIG. 3, as should be clear to those of skill in the art, the various embodiments of the methods of the present disclosure are implemented via computer software or executable instructions or code. FIG. 3 is a schematic representation of an embodiment of a system 400 for implementing the methods of the present disclosure. The system includes at least a processor 410 including a Central Processing Unit (CPU), memory 420, and interface hardware 430 for connecting to external sources of data 435, for example, via the Internet 440.

Any of the raw, filtered, or generated call history tables, and other databases and tables described herein for implementing the methods of the present invention, may be stored in an external memory 435, and accessed remotely, for example, via the Internet or other means, or may be stored in one of a number of local memory devices 420 of a system 400 for implementing the methods of the present disclosure.

Referring still to FIG. 3, the system 400 can be a computer with display 450 and input keypad or keyboard 460, and a media drive 465, or a handheld or other portable device with a display, keypad, memory, processor, network interface, and a media interface such as a flash drive. The memory 420 includes computer readable memory accessible by the CPU for storing instructions that when executed by the CPU 410 causes the processor 410 to implement the steps of the methods described herein. The memory 420 can include random access memory (RAM), read only memory (ROM), a storage device including a hard drive, or a portable, removable computer readable medium, such as a compact disk (CD) or a flash memory, or a combination thereof. The computer executable instructions for implementing the methods of the present invention may be stored in any one type of memory associated with the system 400, or distributed among various types of memory devices provided, and the necessary portions loaded into RAM, for example, upon execution.

In one embodiment, a non-transitory computer readable product is provided, which includes a computer readable medium, for example, computer readable medium 470 shown in FIG. 3 that can be accessed by the CPU via media drive 465, for storing computer executable instructions or program code for performing the method steps described herein. It should be recognized that the components illustrated in FIG. 3 are exemplary only, and that it is contemplated that the methods described herein may be implemented by various combinations of hardware, software, firmware, circuitry, and/or processors and associated memory, for example, as well as other components known to those of ordinary skill in the art.

While the invention has been particularly shown and described with reference to specific embodiments, it should be apparent to those skilled in the art that the foregoing is illustrative only and not limiting, having been presented by way of example only. Various changes in form and detail may be made therein without departing from the spirit and scope of the invention. Therefore, numerous other embodiments are contemplated as falling within the scope of the present invention as defined by the accompanying claims and equivalents thereto.

As described above, while particular embodiments have been developed relating primarily to the prediction of bust-out fraud, one of skill in the art will recognize that the system and method can be similarly applied to the calculation of credit-worthiness and to the prediction of other negative credit behavior.

What is claimed is:

1. A computer-implemented method for calculating a score indicating a propensity of a person to engage in negative credit practices from telephone call records, the method comprising:
retrieving telephone call data comprising records of telephone calls between users;
forming a social graph from the telephone call data, wherein the users are represented as nodes and an existence of a record of at least one telephone call between a pair of users is represented as an edge connecting a corresponding node pair on the social graph;
determining a strength of a relationship of each of a plurality of second users having a degree of separation of one with a first user using the social graph of records of telephone calls between users;
assigning a weight corresponding to the strength of the relationship to the edge connecting the corresponding node pair;
assigning an initial score to the first user and to each of the plurality of second users, the initial score indicating a propensity for engaging in a negative credit practice, a score of zero indicating a lack of a record of engaging in the negative credit practice; and
determining a score for the first user to engage in the negative credit practice comprising calculating a first degree cumulative score based on the initial scores assigned to the second users having a degree of separation of one and the weight of the edges connecting the corresponding node pairs.

2. The computer-implemented method of claim 1, wherein calculating the first degree cumulative score for the first user comprises:
weighting the initial score assigned to each of the plurality of second users by the corresponding weight of the edge connecting the corresponding node pair to form a plurality of weighted scores for the second users, and
adding the plurality of weighted scores for the second users to calculate the first degree cumulative score.

3. The computer-implemented method of claim 2, wherein determining the score for the first user comprises adding the first degree cumulative score to the initial score for the first user, a higher credit score representing a higher propensity that the first user will engage in the negative credit practice.

4. The computer-implemented method of claim 1, further comprising:
identifying a plurality of third users having a degree of separation of two with the first user using the social graph of records of telephone calls between users, wherein an existence of a record of at least one telephone call between one of the plurality of third users and one of the plurality of second users is represented as an edge connecting a corresponding second node pair on the social graph;
determining a strength of a relationship of each of the plurality of third users with each of the plurality of second users using the records of telephone calls;
assigning a weight corresponding to the strength of the relationship to the edge connecting each of the corresponding second node pairs formed by one of the plurality of third users and one of the plurality of second users;
assigning an initial score to each of the plurality of third users, the initial score indicating a propensity for engaging in a negative credit practice, a score of zero indicating a lack of a record of engaging in the negative credit practice; and
wherein determining the score for the first user to engage in the negative credit practice further comprises calculating a second degree cumulative score based on the initial scores assigned to the third users, the degree of separation between each of the plurality of third users and the first user, and the weight of the edges connecting the corresponding second node pairs.

5. The computer-implemented method of claim 4, wherein calculating the first degree cumulative score for the first user comprises:
weighting the initial score assigned to each of the plurality of second users by the corresponding weight of the edge connecting the corresponding node pair to form a plurality of weighted scores for the second users, and
adding the plurality of weighted scores for the second users to calculate the first degree cumulative score; and
calculating the second degree cumulative score for the first user comprises:
weighting the initial score assigned to each of the plurality of third users by the corresponding weight of the edge connecting the corresponding second node pair and by the inverse of the square of the degree of separation with the first user to form a plurality of weighted scores for the third users; and
adding the plurality of weighted scores for the third users to calculate the second degree cumulative score;
wherein determining the score for the first user comprises adding the first degree cumulative score and the second degree cumulative score to the initial score for the first user, a higher credit score representing a higher propensity that the first user will engage in the negative credit practice.

6. The computer-implemented method of claim 1, further comprising:
identifying a degree of separation n with the first user for a user, where n is greater than 1, using the social graph of records of telephone calls between users, and a path connecting the user having the degree of separation of n with the first user comprising a set of edges connecting the corresponding node pairs on the social graph;
assigning a weight corresponding to a strength of a relationship between a pair of users represented by the corresponding node pair for each of the edges along the path using the records of telephone calls;
assigning an initial score to each user along the path from the user of degree of separation of n and the first user, the initial score indicating a propensity for engaging in a negative credit practice, a score of zero indicating a lack of a record of engaging in the negative credit practice; and
wherein determining the score for the first user to engage in the negative credit practice further comprises calculating a degree-weighted score for each of the users along the path based on the initial score assigned to each user, the degree of separation of each user along the path and the first user, and the weight of the edges connecting the corresponding node pairs along the path.

7. The computer-implemented method of claim 6, wherein calculating the degree-weighted score for each of the users along the path comprises:
weighting the initial score assigned to each of the users along the path by the corresponding weight of the edge connecting the corresponding node pair and by the inverse of the square of the degree of separation of the user along the path with the first user to form a plurality of degree-weighted scores for the users along the path connecting the user with degree of separation n and the first user; and
adding the plurality of degree-weighted scores to the first cumulative score and to the initial score for the first user to calculate the score for the first user, a higher credit score representing a higher propensity that the first user will engage in the negative credit practice.

8. The computer-implemented method of claim 1, wherein the negative credit practice is bust-out fraud.

9. The computer-implemented method of claim 1, wherein the score is an indicator of non-compliant merchant behavior.

10. The computer-implemented method of claim 1, wherein the negative credit practice is bankruptcy and the score is an indicator for predicting bankruptcy.

11. The computer-implemented method of claim 1, wherein the edge is a directed edge directed toward the first user on the social graph, and the weight of the directed edge further reflects a degree of influence of one user over an other user in the corresponding node pair, the one user having a higher degree of separation from the first user than the other user.

12. The computer-implemented method of claim 1, wherein the initial scores indicating a propensity for engaging in the negative credit practice are derived from a credit bureau or credit reporting agency.

13. The computer-implemented method of claim 1, wherein for each pair of users represented by the corresponding node pair on the social graph, the weight corresponding to the strength of the relationship between the pair of users is determined based on at least one of a frequency of calls between the users, a total number of calls, an average call duration, a direction of calls, and an immediacy of a reciprocating call.

14. The computer-implemented method of claim 12, wherein the telephone call data comprising records of telephone calls between users includes an identifying number for each of the users for matching with the initial scores derived from the credit bureau or credit reporting agency for an individual.

15. The computer-implemented method of claim 1, further comprising filtering the telephone call data for forming the social graph by removing at least one of calls that are shorter than a predetermined duration, calls to or from business phone numbers, calls to or from customer service numbers, calls to a user's voicemail service, toll-free calls, calls to or from public phones.

16. The computer-implemented method of claim 15, wherein each of the retrieved telephone call data records comprise at least a calling number, a receiving number, a time of call, a call duration, and a geolocation from which the telephone call originated, the method further comprising generating usage statistics for each calling number.

17. The computer-implemented method of claim 16, further comprising generating an initial call history fingerprint for each of the calling numbers comprising a list of phone numbers called, the call duration, frequency, and time of day associated with each phone number called, periodically generating an updated call history fingerprint for each of the calling numbers, and identifying a change of ownership of one of the calling numbers based on a comparison between the initial call history fingerprint and the updated call history fingerprint.

18. The computer-implemented method of claim 16, the method further comprising applying the usage statistics to identify multiple calling numbers used by a single user, assigning the telephone call records associated with the multiple calling numbers to an identification number associated with the single user, wherein one of the nodes of the social graph corresponds to the multiple calling numbers associated with the single user.

19. The computer-implemented method of claim 16, the method further comprising applying the usage statistics to identify pooled numbers, and removing the identified pooled numbers from the records of the telephone call data for forming the social graph.
